(19) United States
(12) Patent Application Publication
(10) Pub. No.: US 2025/0338202 A1
(43) Pub. Date: Oct. 30, 2025

(54) EXTENDED WIRELESS NETWORK USING ACCESS POINTS IN ELECTRICAL POWER ENCLOSURES FOR USE IN POOL AND SPA SYSTEMS

(71) Applicant: ZODIAC POOL SYSTEMS LLC, Carlsbad, CA (US)

(72) Inventors: Minas Minassian, Carlsbad, CA (US); Darin Eames, Carlsbad, CA (US)

(73) Assignee: ZODIAC POOL SYSTEMS LLC, Carlsbad, CA (US)

(21) Appl. No.: 19/083,865

(22) Filed: Mar. 19, 2025

Related U.S. Application Data
(60) Provisional application No. 63/640,323, filed on Apr. 30, 2024.

(51) Int. Cl. H04W 48/16; H04W 4/38; H04W 88/08

(52) U.S. Cl. CPC H04W 48/16; H04W 4/38; H04W 88/08

(57) ABSTRACT

Systems and methods for implementing extended wireless network using access points in electrical power enclosures for use in pool and spa systems are disclosed. In an example method, a computing system receives configuration information for a first wireless access point including a SSID and an IP address, in which the first wireless access point is included in a first electrical enclosure and is configured to communicate with first pieces of pool or spa equipment. The computing system receives configuration information for a second wireless access point, in which the second wireless access point is included in a second electrical enclosure and is configured to communicate with second pieces of pool or spa equipment. The computing system outputs the configuration information to the first and second wireless access points to initialize a wireless network by causing the first and second wireless access points to communicate.

### CROSS-REFERENCE TO RELATED APPLICATION

This application claims priority to provisional application U.S. Ser. No. 63/640,323 entitled “EXTENDED WIRELESS NETWORK USING ACCESS POINTS IN ELECTRICAL POWER ENCLOSURES FOR USE IN POOL AND SPA SYSTEMS” and filed on Apr. 30, 2024, the entire disclosure of which is incorporated herein by reference for any purpose.

### FIELD

This disclosure relates to pool and spa networks and more particularly, although not exclusively, to systems and techniques for extending the range of a wireless network for pool and spa devices.

### BACKGROUND

A conventional pool and spa wireless network may include an automation controller (e.g., micro-controller and interface) that maintains a network connection with multiple items of pool equipment (e.g., pumps, heaters, chlorinators, speakers, lights, and other devices wirelessly connectable to the network, etc.). Communication between the automation controller and the multiple items of pool equipment is critical to the maintenance of a well-run pool or spa. For example, failures in communication between the automation controller and the multiple items of pool equipment may result in delays in the deployment of pool treatments or may prevent the proper operation of various items of pool equipment, such as the carefully choreographed adjustment of lights, speakers, heaters to maintain a constant temperature throughout a pool, etc.

Additionally, WiFi range may be limited. For example, some WiFi routers operating on the 2.4 GHz frequency band generally only have a range of roughly 300 feet outdoors, and 150 feet indoors. In larger pools, or locations with multiple pools or spas at different locations outside of the range of an individual WiFi router, a single WiFi router is unable to connect multiple items of pool equipment across different locations.

### SUMMARY

Systems and methods for implementing extended wireless network using access points in electrical power enclosures for use in pool and spa systems are disclosed. An example pool or spa system includes a first electrical enclosure including a first electrical power source and a first wireless networking device configured to receive power from the first electrical power source and communicate with one or more first pieces of pool or spa equipment. The pool or spa system further includes a second electrical enclosure including a second electrical power source and a second wireless networking device configured to receive power from the second electrical power source and communicate with one or more second pieces of pool or spa equipment and in network communication with the first wireless networking device.

In an example method of configuring a wireless network for a pool or spa system, a computing system receives first configuration information for a first wireless access point including a SSID and an IP address, in which the first wireless access point is included in a first electrical enclosure and is configured to communicate with one or more first pieces of pool or spa equipment. The computing system receives second configuration information for a second wireless access point, in which the second wireless access point is included in a second electrical enclosure and is configured to communicate with one or more second pieces of pool or spa equipment. The computing system outputs the first configuration information to the first wireless access point and the second configuration information to the second wireless access point to initialize the wireless network by causing the first wireless access point to communicate with the second wireless access point.

Another example method for deploying a wireless network for a pool or spa system, includes installing a first wireless networking device in a first electrical enclosure configured to communicate with one or more first pieces of pool or spa equipment located in a first region, wherein the first wireless networking device has a first range. The method includes installing a second wireless networking device in a second electrical enclosure configured to communicate with one or more second pieces of pool or spa equipment location in a second region, the first region and the second region separated by a distance greater than the first range. The method includes deploying the wireless network comprising the first wireless networking device and second wireless networking device.

### BRIEF DESCRIPTION OF THE DRAWINGS

FIG. 1 depicts a communication network for extended wireless network using access points in electrical power enclosures for use in pool and spa systems, according to some aspects of the present disclosure.

FIG. 2 illustrates a flow chart representing a process for implementing extended wireless network using access points in electrical power enclosures for use in pool and spa systems, according to some aspects of the present disclosure.

FIGS. 3A, 3B, 3C, and 3D illustrate various arrangements of electrical power enclosures and respective wireless access points, according to some aspects of the present disclosure.

FIG. 4 illustrates a flow chart representing a process for configuring extended wireless network using access points to operate pool and spa equipment, according to some aspects of the present disclosure.

FIG. 5 illustrates examples of components of a computer system, according to at least one example.

### DETAILED DESCRIPTION

Examples described herein relate to systems, devices, and techniques for extending the range of wireless networks of pool or spa networks. Pool or spa systems may include a number of pieces of equipment such as pumps, heaters, chlorinators, speakers, lights, or other devices, spread out over a large area. Traditionally, such equipment was powered and controlled from a central location using a pool automation controller. More recently, wireless networking (usually referred to as “WiFi” to refer to the collection of technologies implementing wireless networks) has enabled the control function to be shifted to a fully networked approach with no physical connections required, other than electrical power.

Wireless operation of pool and spa equipment using the pool automation controller is straightforward when the footprint of the poor or spa is small (e.g., equipment located tens of feet from the pool automation controller). Wireless operation at short ranges such as these can be effective with minimal equipment such as a wireless router adjacent to the pool automation controller.

However, for larger footprints or more diffuse equipment, additional wireless networking hardware may be needed to ensure adequate wireless signal strength, robustness of connection, bandwidth, and overall network reliability, particularly in environments with high interference, physical obstructions, or increased device density. For example, a pump mounted 150 feet away from the pool automation controller may still connect to a 2.4 GHz WiFi network, but performance could be degraded due to interference from trees, walls, or other structures. Modern WiFi equipment can operate with higher speeds and bandwidth at higher frequency bands such as 5 GHz, at the cost of even shorter ranges and susceptibility to interference. Existing pool or spa networks cannot effectively control pool or spa equipment that exceeds the base range of wireless routers or is affected by a reduced wireless signal due to physical interference that is common in pool or spa setups such as walls, waterfalls, water, and so on.

Further compounding these difficulties is that, in addition to diffuse pool or spa equipment, existing systems include electrical power devices for powering pool or spa equipment that may be physically distant from wireless networking components. Wireless networking equipment such as wireless routers located far from power sources may require long power cables, which can lead to voltage drops or increased resistance, resulting in power instability. Likewise, long network cables may be required in some cases, such as Ethernet cables to connect wireless routers to a network. Ethernet cable runs exceeding 100 meters (328 feet), can experience signal degradation, increased latency, and reduced data transmission reliability. Additionally, running long cables outdoors can significantly increase installation complexity, cost, and potential points of failure due to weather exposure, physical damage, or interference. For example, in some cases, pool and spa systems may be retrofitted with new equipment such as networking capabilities. In these cases, it may not be practical to run Ethernet cables. For such retrofitted pool or spa systems, wireless networking is often the best option but may not be practical to implement using a single wireless access point.

Systems and methods for implementing extended wireless networks using access points in electrical power enclosures for use in pool and spa systems are disclosed to address these challenges. An example pool or spa network may include a network of wireless networking devices (e.g., a traditional WiFi network with a wireless router and standalone wireless access points or a mesh network with multiple interconnected nodes). The wireless networking devices may be located in, adjacent to, or on an electrical power enclosure, also referred to as electrical enclosures, and may be powered at the electrical power enclosure. For example, a pool or spa may include various electrical power enclosures, sometimes referred to as “cans,” which may include various relays, switches, and other electrical equipment to provide power and/or communication capabilities to equipment and devices at a pool or spa. The electrical power enclosures may include wireless networking devices such as wireless routers or access points or may provide electrical ports to connect such wireless networking devices locally, with a minimum of cable. Co-location of the electrical power sources with wireless networking equipment can mitigate the difficulties described above associated with long cable lengths.

A network suitable for deployment at a pool or spa system may include a wireless router, such as a home WiFi router, located within a home of a pool owner. The network may also include a first access point housed at and/or powered by a main electrical power enclosure. As described herein, locating an access point “at” an electrical enclosure may include locating the access point adjacent to the electrical enclosure, mounting the access point to an exterior surface of the electrical enclosure, mounting the access point to an interior surface of the electrical enclosure, housing the access point within the electrical enclosure, or other suitable mounting approaches described herein. A first set of items of pool or spa equipment located within range of the first access point may connect wirelessly to the first access point. Additional items of pool or spa equipment may be connected to the wireless network via the first access point using wired network connections such as Ethernet.

The network may also include a second access point located at and/or powered by an extending electrical power enclosure, also referred to as an “expansion can,” which is an electrical power enclosure at a location different from the main electrical power enclosure. The first access point and the second access point may be communicatively connected via a wireless network link or via a hardwired link (e.g., via an Ethernet cable). A second set of items of pool or spa equipment located within range of the second access point may connect to the second access point. Again, additional items of pool or spa equipment may be connected to the wireless network via the second access point using wired network connections such as Ethernet.

In some cases the extending electrical power enclosure may be significant distance from the main electrical power enclosure (e.g., 100s or 1000s of feet) such that the wireless signal output by the first access point cannot reach, or cannot reach with sufficient strength, the second set of items of pool or spa equipment. Accordingly, the combination of the extending electrical power enclosure with the second access point effectively extends the effective range or area of the network, while maintaining a compact equipment deployment profile including the electrical power enclosures and the co-located access points.

In addition to addressing the challenges described above, the techniques for implementing extended wireless network using access points in electrical power enclosures for use in pool and spa systems has several more advantages that constitute improvements to the technical field of remote control of pool and spa systems. These techniques not only enhance the range and reliability of wireless networks in complex pool and spa environments but also streamline the integration of wireless networking equipment with existing infrastructure. Co-location of access points within or adjacent to electrical power enclosures can minimize the need for extensive wiring, reducing installation time and associated costs. Additionally, the disclosed approach can improve network scalability by allowing new equipment or devices to be more easily added to the system without significant reconfiguration. For instance, additional electrical enclosures can be added without reconfiguration of existing enclosures. Further, the integration of electrical enclosures with access points can support the control of widely dispersed pool and spa equipment even in challenging environments with physical obstructions or interference, ensuring consistent performance across a wide operational area.

These illustrative examples are given to introduce the reader to the general subject matter discussed herein and the disclosure is not limited to these examples. The following sections describe various additional non-limiting examples of systems and methods for implementing extended wireless network using access points in electrical power enclosures for use in pool and spa systems.

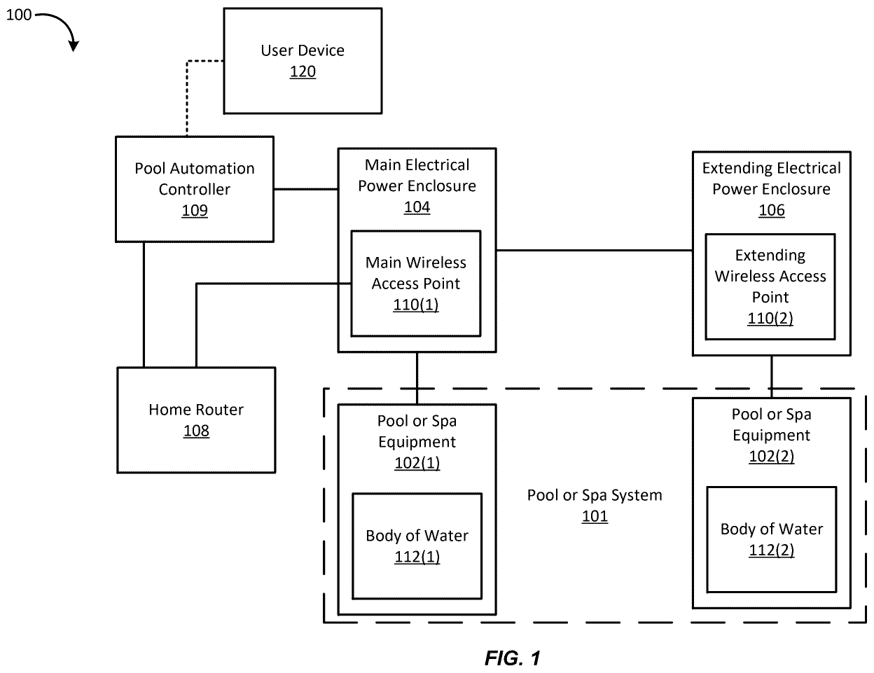

Turning now to the figures, FIG. 1 depicts a communication network 100 for extended wireless network using access points in electrical power enclosures for use in pool and spa systems, according to some aspects of the present disclosure. The communication network 100 includes a main access point 110(1) (or, in some examples, first access point) and an extending access point 110(2) (or, in some examples, second access point) providing wireless network coverage across a pool or spa system 101. The main access point 110(1) and an extending access point 110(2) may provide wireless network coverage across multiple bodies of water, such as a first body of water 112(1) representing a first pool or spa and a second body of water 112(2) representing a second pool or spa, allowing pool or spa equipment and other devices to connect to the same communication network. It should be noted that the characterization of the pool or spa system 101 as including a first and second body of water 112(1), 112(2) is just an example configuration. For instance, a first and second body of water 112(1), 112(2) may refer to portions of a single body of water. In general, the systems and methods according to this disclosure can apply to any pool or spa system 101 that is sufficiently large to warrant multiple wireless access points.

FIG. 1 depicts the connection of the main access point 110(1) at a main electrical power enclosure 104 to a home router 108 (e.g., a WiFi router). The home router 108 can provide internet connectivity via a connection to a wide-area network (WAN) provided by an internet service provider (ISP) and manages network traffic between connected devices. The home router 108 can wirelessly communicate with the main access point 110(1) or, in some examples, use a wired connection for more stable data transmission. The main access point 110(1) is connected using a wired (e.g., Ethernet) or wireless connection to the extending access point 110(2) associated with an extending electrical power enclosure 106.

The main access point 110(1) is connected wirelessly to a first collection of items of pool or spa equipment 102(1) and the extending access point 110(2) is connected to a second collection of items of pool or spa equipment 102(2). The collection of items of pool or spa equipment 102(1), 102(2) may include pumps, filtration systems, heaters, chlorinators, cleaners, chemical dispensers, water level sensors, lighting systems, jet systems, flow and pressure sensors, and so on. In addition to the items of pool or spa equipment 102(1), 102(2) in wireless communication with the respective access points 110(1), 110(2), there may be additional items of pool or spa equipment in wired network communication. The access points 110(1), 110(2) may include, for instance, a number of Ethernet ports to support wired communication with additional items of pool or spa equipment.

In some examples, both the main access point 110(1) and the extending access point 110(2) may share the same SSID, IP address, and other wireless network characteristics and credentials such that they provide access to the same communication network. The first collection of items of pool or spa equipment 102(1) and the second collection of items of pool or spa equipment 102(2) may therefore be connected to the same wireless network through different access points by joining the network with the corresponding SSID. By using multiple access points located at different electrical power enclosures, the overall range and wireless coverage of the communication network is increased, allowing the communication network to cover more area and diffuse pool or spa equipment.

For example, the main access point 110(1) may provide wireless access to the communication network to the first collection of items of pool or spa equipment 102(1) located at the first body of water 112(1). The extending access point 110(2) may provide wireless access to the communication network at the second body of water 112(2). The first body of water 112(1) and the second body of water 112(2) may be at two different locations outside of the range of the access points at each respective body, such that the first collection of items of pool or spa equipment are not within range of the extending access point 110(2), and the second collection of items of pool or spa equipment are not within range of the main access point 110(1). This can allow items of pool or spa equipment to remain connected to the network despite being outside of the range of the main access point 110(1) when the items of pool or spa equipment are within range of the extending access point 110(2).

The range of the main or extending access points 110(1), 110(2) may vary according to the layout, size, and structural features of the pool or spa system 101. In a typical example, the range may be between 100 ft and 300 ft, depending on environmental factors such as interference from other devices or physical obstructions like walls or foliage. The range may also be limited on wireless hardware constraints, such as antenna quality, signal amplification capabilities, or frequency bands (e.g., 2.4 GHz or 5 GHz).

In some examples, the main access point 110(1) and the main electrical power enclosure 104 may be located at a first location. A first set of items of pool or spa equipment 102(1) within range of the main access point, such as within 300 feet, may connect to the main access point 110(1). A first extending access point 110(2) powered by a first extending electrical power enclosure 106 may connect to the main access point by ethernet. The first extending access point 110(2) may be located at a second location outside of the range of the main access point 110(1). In some examples, the first extending access point 110(2) may be located within range of the main access point 110(1) to provide continuous wireless network coverage in the area between the first location and the second location. A second set of items of pool or spa equipment 102(2) may be located within range of the first extending access point 110(2). The first extending access point 110(2) may have the same SSID as the main access point 110(1) so that the first collection of items of pool or spa equipment 102(1) and the second collection of items of pool or spa equipment 102(2) are both connected to the same wireless network despite being connected to different access points.

The communication network 100 includes pool automation controller 109, which is also connected to the WAN or other external network via home router 108. The pool automation controller 109 can be a computing system located in proximity to the pool or spa system 101 to effect centralized control of the pool or spa system 101. The pool automation controller 109 can include a processing subsystem. The processing subsystem may include one or more processors that are communicatively coupled with a memory, such as physical, random-access memory or a hard disk drive. The memory can include one or more non-transitory computer-readable media that include processor-executable instructions to perform various operations for the control and operation of the pool automation controller 109. The pool automation controller 109 can execute software locally as well as access software or data stored on remote server or in cloud-hosted network locations.

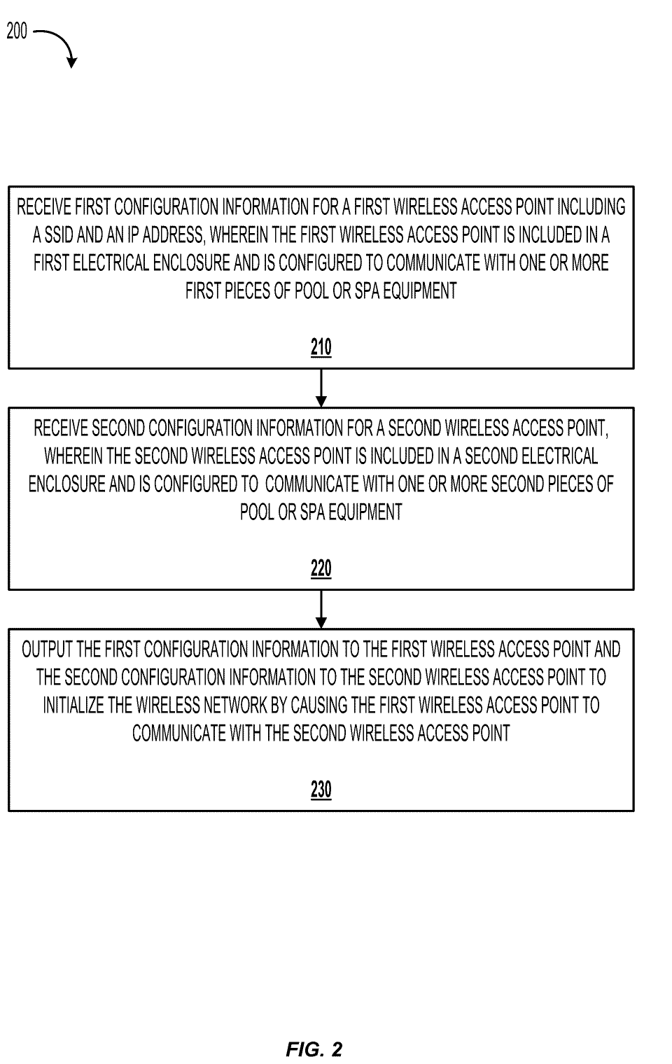

The pool automation controller 109 may include a user interface for configuring and operating the communication network 100 and the components therein. The pool automation controller 109 can also be configured, operated, or maintained using an application executing on a user device 120. The user device 120 may be a smartphone, tablet, smartphone, laptop, or any other suitable device for executing pool automation controller client software. The user device 120 may be communicatively coupled with the pool automation controller 109 using a wired or wireless connection, as indicated using a dashed line. Various functions of the pool automation controller 109 can be configured or initiated using the user device in tandem with or in lieu of the local user interface, such as the process 200 described in FIG. 2 below.

While FIG. 1 depicts two electrical power enclosures, in various examples, the pool or spa network may include any number of access points, a WiFi router (e.g., home router 108), and dispersed items of pool or spa equipment. In some examples, one or more of the access points are powered by and housed at respective electrical power enclosures. The electrical power enclosures may each include an access point associated with an electrical power enclosure. The electrical power enclosures may include a main electrical power enclosure 104, and one or more extending electrical power enclosures (e.g., extending electrical power enclosure 106). The main electrical power enclosure 104 may include a main access point connected to the WiFi router. The connection between the WiFi router and the access point at the main electrical power enclosure, sometimes be referred to as the “main access point”, may be wired, such as using Ethernet, or wireless, such as using one or more IEEE 802.11 standards from the IEEE 802.11 family of communication standards. The main electrical power enclosure may house and power the main access point. A subset of the dispersed collection of pool or spa equipment may connect to the network through the main access point. While a wireless connection may be easiest to install and maintain, in general the connection between the main access point located at the main electrical power enclosure and the one or more items of pool or spa equipment may be wired or wireless.

Extending access points at and powered by one or more extending electrical power enclosures (e.g., extending electrical power enclosure 106) may connect to the main access point through a wired connection, such as by Ethernet, or a wireless connection, such as by WiFi (e.g., IEEE 802.11 standards). The extending access points may use the same SSID as the main access point so that devices, such as any of the dispersed pool or spa equipment, remain connected to the same wireless network when within range of either the main access point or one of the extending access points. In this way, pool or spa equipment can be moved throughout the pool or spa equipment without any need for network reconfiguration, even when such movement results in a connection to a different access point.

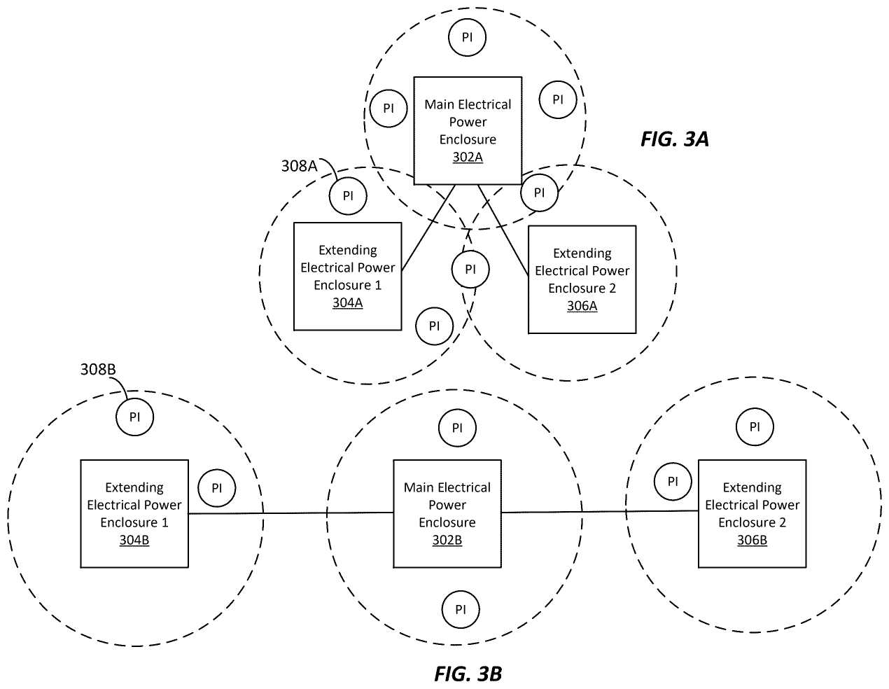

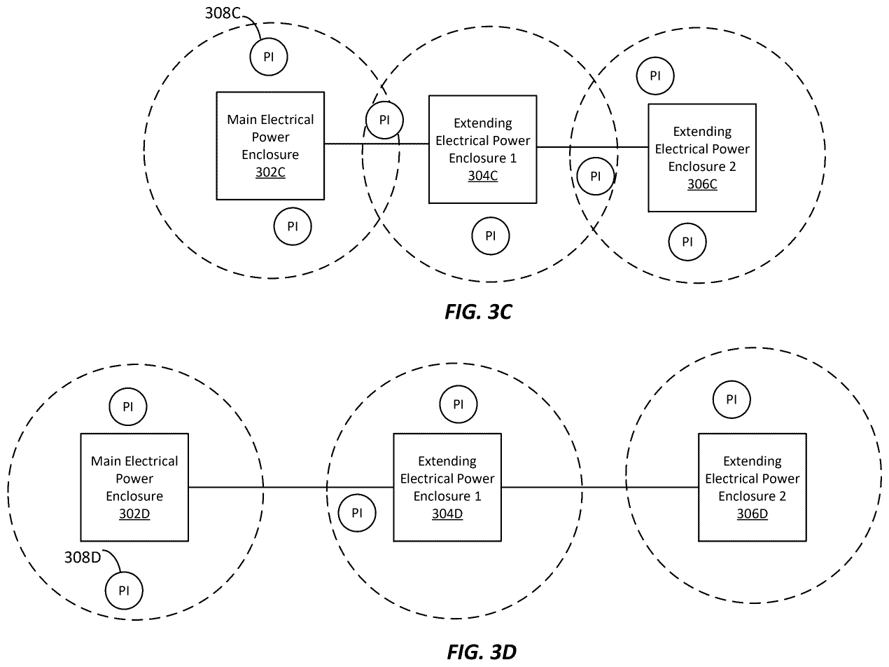

For multiple extending access point systems, several configurations may be used. For example, a second extending access point powered at a second extending electrical power enclosure may be located at a third location. The second extending access point may connect to one of or both of the main access point and first extending access point by ethernet or may connect wirelessly. A third set of items of pool or spa equipment may be located within range of the second extending access point and connect to the wireless network through the second extending access point. The second extending access point may have the same SSID as the main access point and the first extending access point so that the third set of items of pool or spa equipment are connected to the same wireless network as the first and second sets of items of pool or spa equipment. Examples of configurations for multiple extending access point systems are shown below in FIGS. 3A-3D.

FIG. 2 illustrates a flow chart representing a process 200 for implementing extended wireless network using access points in electrical power enclosures for use in pool and spa systems, according to some aspects of the present disclosure. Process 200 may represent various processes performable by components of the system described in the description of FIG. 1 and FIG. 3A-3D, such as the pool automation controller 109. This process, and any other processes described herein, is illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

Process 200 may begin at block 210 which includes receiving, by a computing system such as the pool automation controller 109, first configuration information for a first wireless access point including a SSID and an IP address, in which the first wireless access point is included in a first electrical enclosure and is configured to communicate with one or more first pieces of pool or spa equipment. For example, the first wireless access point may correspond to the access point 110(1) of FIG. 1 enclosed in main electrical power enclosure 104. The first electrical enclosure may be disposed at a first location at or adjacent to a first body of water, such as the first body of water 112(1) described in the description of FIG. 1. The pieces of pool or spa equipment item may include, for example, a pump, chlorinator, light, heater, cleaner, speaker, or other item of equipment or device that may connect to a wireless network wirelessly or via wired connection. In some examples, the first wireless access point can first be installed in a first region, in which the first wireless networking device has an effective range sufficient for configuring or controlling the one or more first pieces of pool or spa equipment.

In example communication network 100 of FIG. 1, the wireless point 110(1) is also connected to home router 108, providing external network access to the wireless network being implemented in this method to enable remote control and configuration. In some examples, the first wireless access point connects to the home router 108 through a wireless connection. In further examples, the home router 108 may include an ethernet port, and the first wireless access point may connect to the home router 108 using a wired connection such as Ethernet.

At block 220, process 200 may include receiving, by the computing system, second configuration information for a second wireless access point, wherein the second wireless access point is included in a second electrical enclosure and is configured to communicate with one or more second pieces of pool or spa equipment. As with respect to block 210, the second wireless access point may correspond to the wireless point 110(2) of FIG. 1 enclosed in extending electrical power enclosure 106. The second electrical enclosure may be disposed at a first location at or adjacent to a second body of water, such as the second body of water 112(2) described in the description of FIG. 1.

The first and second electrical enclosures and their associated networking components and powered pool or spa equipment may be separated by a significant distance, such that the first wireless access point may be out of range for controlling the one or more second items of pool or spa equipment. In various examples, the distance between the enclosures and pool or spa equipment may be 50, 100, 150, 200, 250, 300, 350, or 400 feet, or other distance according to the physical and topological deployment.

In some examples, the first and second access points may be connected wirelessly. For example, the second wireless access point may be the extending access point 110(2) and the second electrical power enclosure may be the extending electrical power enclosure 106 described in the description FIG. 1. In some examples, the second wireless access point can first be installed in a second region, in which the second wireless networking device has an effective range sufficient for configuring or controlling the one or more second pieces of pool or spa equipment.

At block 230, process 200 may include outputting, by the computing system, the first configuration information to the first wireless access point and the second configuration information to the second wireless access point to initialize a wireless network by causing the first wireless access point to communicate with the second wireless access point. The wireless network can be characterized by a service set identifier (SSID) and internet protocol (IP) address. The SSID is a unique name assigned to the wireless network to distinguish it from other wireless networks that can be shared among all wireless access constituting the wireless network. In some examples, the second wireless access point may be initially installed with a different SSID configured. In such cases, the SSID of the second wireless access point can be updated to match the SSID of the wireless network (and the first wireless access point). In some examples, other network credentials and characteristics of the second access point may also update to match the first access point, such as IP addresses, device names, etc.

The second pieces of pool or spa equipment may connect to the network through the second wireless access point wirelessly or using a wired connection (e.g., Ethernet). Because the second access point matches the network credentials and other characteristics of the first access point, the second pool or spa equipment item may be connected to the same network as the first pieces of pool or spa equipment, despite being connected to a different access point.

While example process 200 illustrates a pool or spa system with a wireless network including two electrical enclosures and associated wireless devices, in general pool or spa systems may include any number of extended electrical enclosures, in which each enclosure includes an electrical power source configured to power one or more associated (e.g., proximate) pieces of pool or spa equipment and an independent wireless networking device or access point configured to communicate wirelessly with the one or more pieces of pool or spa equipment and in network communication with the first wireless access point or other first networking device.

FIGS. 3A, 3B, 3C, and 3D illustrate various arrangements of electrical power enclosures and respective wireless access points, according to some aspects of the present disclosure. Multiple extending access points may connect to the main access point directly, sometimes referred to as a “hub-and-spoke” deployment. In some examples, the main access point powered at the main electrical power enclosure may connect to a first extending access point powered at a first extending electrical power enclosure, and subsequent extending access points powered at subsequent extending electrical power enclosures may connect to the first extending access point. The extending access points may be positioned at different locations from one another and the main access point. This configuration can be referred to as a chained network configuration.

FIGS. 3A and 3B show example hub-and-spoke configurations in which the access point associated with main electrical power enclosures 302A and 302B are connected to each of the access points of extending electrical power enclosures 304A, 306A and 304B, 306B, respectively. The dashed circles surrounding each access point represent the range of an access point associated with each of the electrical power enclosures. For example, in FIG. 3A, the dashed circles overlap representing an overlap in coverage between access points. Each of FIGS. 3A-3D includes a number of pool items 308A, 308B, 308C, and 308D. Pool items within the dashed circle of an access point illustrate a wireless connection to the respective access point. The pool items may be pieces of pool or spa equipment such as pumps, heaters, chlorinators, speakers, lights, and other devices wirelessly connectable to the network. In addition to the pool items shown in FIGS. 3A-3D, additional pool items may be connected with the various respective electrical enclosures using wired network connections such as Ethernet.

FIGS. 3C and 3D illustrate example chained configurations in which the access point associated with the main electrical power enclosures 302C and 302D are directly connected to the access points associated with extending electrical power enclosure 304C and 304D, respectively. Once again, the dashed circles overlap representing an overlap in coverage between access points.

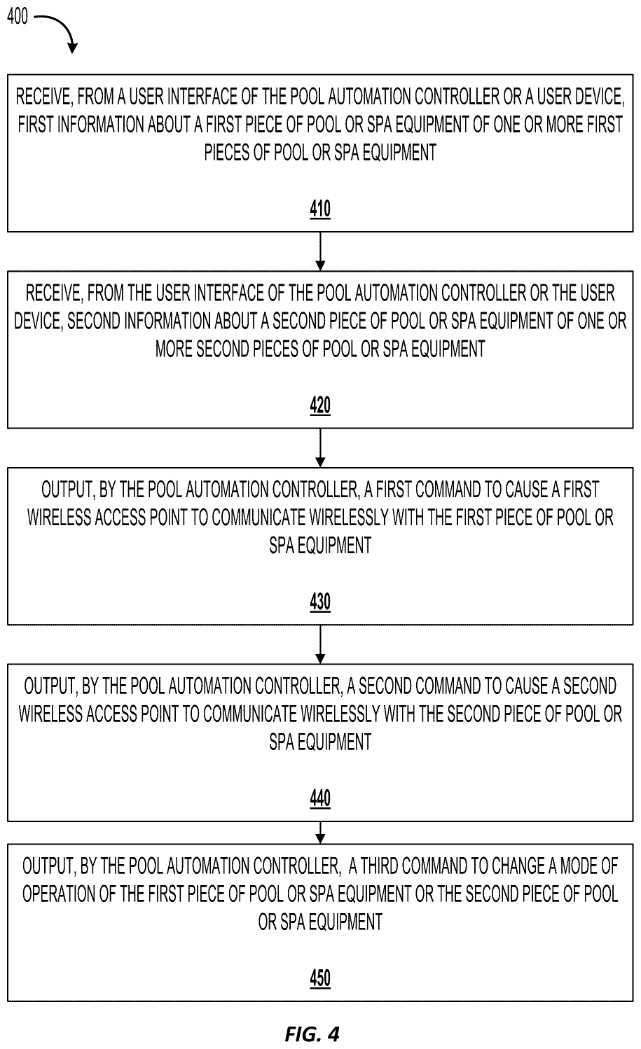

FIG. 4 illustrates a flow chart representing a process 400 for configuring extended wireless network using access points to operate pool and spa equipment, according to some aspects of the present disclosure. Process 400 may represent various processes performable by the system described in the description of FIG. 1 and FIG. 3A-3D. This process, and any other processes described herein, is illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

Process 400 may begin at block 410 in which a computing system receives, from a user interface of the pool automation controller or a user device, first information about a first piece of pool or spa equipment of one or more first pieces of pool or spa equipment. For example, a maintainer of the pool or spa system made add a new piece of pool or spa equipment to the pool or spa system (e.g., install a new valve or heater) with wireless networking and control capabilities. The user interface of the pool automation system can be used to input information about the first piece, including wireless networking configuration information such as the IP address of the device and security details. In some examples, receiving the first information may include receiving the first information as an input at the user interface of the pool automation controller, at a similar user interface of the user device, or via any other suitable device.

At block 420, the computing system receives, from the user interface of the pool automation controller or the user device, second information about a second piece of pool or spa equipment of one or more second pieces of pool or spa equipment. As with block 420, the second piece may be installed by a maintainer. The one or more second pieces of pool or spa equipment may be located at a significant distance from the one or more first pieces of pool or spa equipment such that a first wireless access point in proximity to the one or more first pieces cannot effectively wirelessly connect with the one or more second pieces. The first and second wireless access points may be close enough to establish a wireless network or, alternatively, may be connected using a networking connection such as an Ethernet cable. The second information can again be received as an input at the user interface of the pool automation controller, at a similar user interface of the user device, or via any other suitable device.

At block 430, the computing system outputs, by the pool automation controller, a first command to cause the first wireless access point to communicate wirelessly with the first piece of pool or spa equipment. For example, the first wireless access point can output commands to initialize wireless configuration and control of the first piece using the first information, such as the first device's IP address and security details. The first command may include instructions to establish a secure communication channel using a suitable protocol (e.g., TCP/IP), configure networking settings, or establish authentication/authorization configurations.

At block 440, the computing system outputs, by the pool automation controller, a second command to cause the second wireless access point to communicate wirelessly with the second piece of pool or spa equipment. This block can proceed substantially as block 430, except with respect to the second piece of pool or spa equipment.

At block 450, the computing system outputs a third command to change a mode of operation of the first piece of pool or spa equipment or the second piece of pool or spa equipment. Now that a wireless network exists with wireless configuration and control established over the first and second pieces of pool or spa equipment, the computing system, such as the pool automation controller, can output commands over the wireless network to turn on and off devices, change modes (e.g., change pump speeds or heater setpoints), troubleshoot devices, run diagnostics and run maintenance routines, and so on.

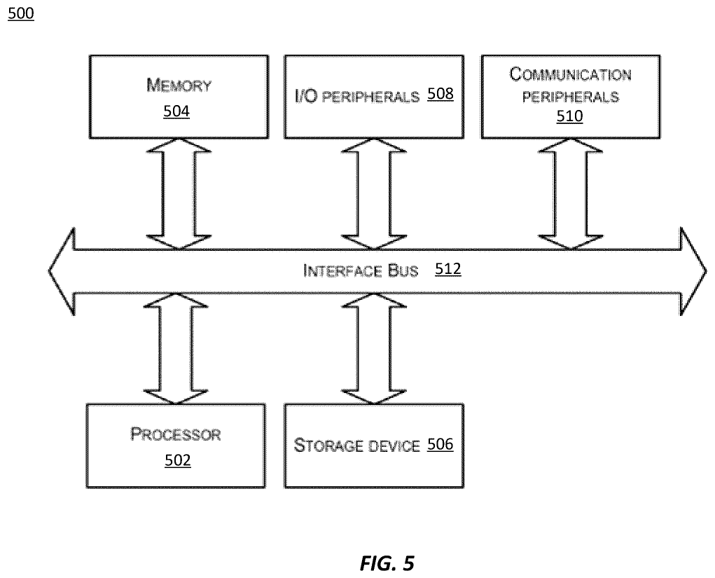

FIG. 5 illustrates examples of components of a computer system 500, according to at least one example. The computer system 500 is an example of controllers and/or microcontrollers of pool equipment and/or pool automation systems including automation controllers, and the like. The computer system 500 may be housed in the main electrical power enclosure and extending electrical power enclosures described in the description of FIG. 1. Computer system 500 may control the access points further described in the description of FIG. 1 and FIGS. 3A-3D, the items of pool or spa equipment connected to the access points, and components within electrical power enclosures providing power to the access points. In some examples, the computer system 500 may connect to the access points.

The computer system 500 may include at least a processor 502, a memory 504, a storage device 506, input/output peripherals (I/O) 508, communication peripherals 510, and an interface bus 512. The interface bus 512 is configured to communicate, transmit, and transfer data, controls, and commands among the various components of the computer system 500. The memory 504 and the storage device 506 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 504 and the storage device 506 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 500.

Further, the memory 504 may include an operating system, programs, and applications. The processor 502 is configured to execute the stored instructions and includes, for example, a logical processing unit, a microprocessor, a digital signal processor, and other processors. The memory 504 and/or the processor 502 can be virtualized and can be hosted within another computing system of, for example, a cloud network or a data center. The I/O peripherals 508 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 508 are connected to the processor 502 through any of the ports coupled to the interface bus 512. The communication peripherals 510 are configured to facilitate communication between the computer system 500 and other computing devices over a communications network and include, for example, a network interface controller, modem, wireless and wired interface cards, antenna, and other communication peripherals.

### General Considerations

The examples described herein are not intended to be mutually exclusive, exhaustive, or restrictive in any way, and the disclosure is not limited to these example embodiments but rather encompasses all possible modifications and variations within the scope of any claims ultimately drafted and issued in connection with the disclosure (and their equivalents). For avoidance of doubt, any combination of features not physically impossible or expressly identified as non-combinable herein may be within the scope of the disclosure. Finally, references to “pools” and “swimming pools” herein may also refer to spas or other water containing vessels used for recreation, training, or therapy.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Although applicant has described devices and techniques for use principally with swimming pools and spas, persons skilled in the relevant field will recognize that the present invention may be employed in connection with other objects and in other manners. Finally, references to “pools” and “swimming pools” herein may also refer to spas or other water containing vessels used for recreation or therapy and for which cleaning is needed or desired.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

### EXAMPLES

A collection of exemplary embodiments is provided below, including at least some explicitly enumerated as “Examples” providing additional description of a variety of example embodiments in accordance with the concepts described herein. These examples are not meant to be mutually exclusive, exhaustive, or restrictive; and the disclosure is not limited to these examples but rather encompasses all possible modifications and variations within the scope of the issued claims and their equivalents.

As used below, any reference to a series of examples is to be understood as a reference to each of those examples disjunctively (e.g., “Examples 1-4” is to be understood as “Examples 1, 2, 3, or 4”).

Example 1 is a pool or spa system comprising: a first electrical enclosure, comprising: a first electrical power source; and a first wireless networking device configured to receive power from the first electrical power source and communicate with one or more first pieces of pool or spa equipment; and a second electrical enclosure, comprising: a second electrical power source; and a second wireless networking device configured to receive power from the second electrical power source and communicate with one or more second pieces of pool or spa equipment and in network communication with the first wireless networking device.

Example 2 is the pool or spa system of example(s) 1, wherein: the first electrical power source is configured to power the one or more first pieces of pool or spa equipment; and the second electrical power source is configured to power the one or more second pieces of pool or spa equipment.

Example 3 is the pool or spa system of any of example(s) 1-2, wherein the one or more first pieces of pool or spa equipment and the one or more second pieces of pool or spa equipment are separated by a distance greater than a range of the first wireless networking device.

Example 4 is the pool or spa system of any of example(s) 1-3, wherein the first electrical enclosure further comprises a pool automation controller configured to operate the one or more first pieces of pool or spa equipment and the one or more second pieces of pool or spa equipment.

Example 5 is the pool or spa system of any of example(s) 1-4, wherein the first wireless networking device and the second wireless networking device provide a wireless network, wherein the wireless network is characterized by a service set identifier (SSID) and an internet protocol (IP) address.

Example 6 is the pool or spa system of any of example(s) 1-5, wherein the first wireless networking device includes a first wireless access point, and the second wireless networking device includes a second wireless access point.

Example 7 is the pool or spa system of example(s) 6, further comprising a pool automation controller, wherein the pool automation controller comprises: one or more non-transitory computer-readable media; and one or more processors communicatively coupled to the one or more non-transitory computer-readable media, the one or more processors configured to execute processor-executable instructions stored in the non-transitory computer-readable media to perform operations including: receiving first configuration information for the first wireless access point including the SSID and the IP address; receiving second configuration information for the second wireless access point; and outputting the first configuration information to the first wireless access point and the second configuration information to the second wireless access point to initialize the wireless network by causing the first wireless access point to communicate with the second wireless access point.

Example 8 is the pool or spa system of example(s) 7, wherein the non-transitory computer-readable media comprises additional processor-executable instructions, and wherein the one or more processors are configured to execute the additional processor-executable instructions to perform operations including: receiving first information about a first piece of pool or spa equipment of the one or more first pieces of pool or spa equipment; receiving second information about a second piece of pool or spa equipment of the one or more second pieces of pool or spa equipment; outputting a first command to cause the first wireless access point to communicate wirelessly with the first piece of pool or spa equipment; and outputting a second command to cause the second wireless access point to communicate wirelessly with the second piece of pool or spa equipment.

Example 9 is the pool or spa system of example(s) 8, wherein the operations further include outputting a third command to change a mode of operation of the first piece of pool or spa equipment or the second piece of pool or spa equipment.

Example 10 is the pool or spa system of example(s) 7, wherein the operations further include updating a second SSID of the second wireless access point to match the SSID of the wireless network.

Example 11 is the pool or spa system of any of example(s) 1-10, further comprising: a plurality of extended electrical enclosures, each enclosure comprising: an electrical power source; and a wireless networking device configured to communicate with the one or more other pieces of pool or spa equipment and in network communication with the first wireless networking device.

Example 12 is the pool or spa system of any of example(s) 1-11, wherein the first electrical enclosure further comprises a wireless router connected to a first external network.

Example 13 is a method of configuring a wireless network for a pool or spa system, comprising: receiving first configuration information for a first wireless access point including a SSID and an IP address, wherein the first wireless access point is included in a first electrical enclosure and is configured to communicate with one or more first pieces of pool or spa equipment; receiving second configuration information for a second wireless access point, wherein the second wireless access point is included in a second electrical enclosure and is configured to communicate with one or more second pieces of pool or spa equipment; and outputting the first configuration information to the first wireless access point and the second configuration information to the second wireless access point to initialize the wireless network by causing the first wireless access point to communicate with the second wireless access point.

Example 14 is the method of example(s) 13, wherein the one or more first pieces of pool or spa equipment and the one or more second pieces of pool or spa equipment are separated by a distance greater than a range of the first wireless networking device.

Example 15 is the method of any of example(s) 13-14, wherein the first electrical enclosure further comprises a pool automation controller configured to operate the one or more first pieces of pool or spa equipment and the one or more second pieces of pool or spa equipment.

Example 16 is the method of any of example(s) 13-15, further comprising: receiving, from a user interface of the pool automation controller, first information about a first piece of pool or spa equipment of the one or more first pieces of pool or spa equipment; receiving, from the user interface of the pool automation controller, second information about a second piece of pool or spa equipment of the one or more second pieces of pool or spa equipment; outputting, by the pool automation controller, a first command to cause the first wireless access point to communicate wirelessly with the first piece of pool or spa equipment; and outputting, by the pool automation controller, a second command to cause the second wireless access point to communicate wirelessly with the second piece of pool or spa equipment.

Example 17 is the method of example(s) 16, further comprising outputting a third command to change a mode of operation of the first piece of pool or spa equipment or the second piece of pool or spa equipment.

Example 18 is the method of any of example(s) 13-17, further comprising updating a SSID of the second wireless access point to match the SSID of the wireless network.

Example 19 is a method for deploying a wireless network for a pool or spa system, comprising: installing a first wireless networking device in a first electrical enclosure configured to communicate with one or more first pieces of pool or spa equipment located in a first region, wherein the first wireless networking device has a first range; installing a second wireless networking device in a second electrical enclosure configured to communicate with one or more second pieces of pool or spa equipment location in a second region, the first region and the second region separated by a distance greater than the first range; and deploying the wireless network comprising the first wireless networking device and second wireless networking device.

Example 20 is the method of example(s) 19, wherein deploying the wireless network comprises: receiving first configuration information for the first wireless networking device including an SSID and an IP address; receiving second configuration information for the second wireless networking device; and outputting the first configuration information to the first wireless networking device and the second configuration information to the second wireless networking device to initialize the wireless network by causing the first wireless networking device to communicate with the second wireless networking device, wherein the wireless network is characterized by a service set identifier (SSID) and internet protocol (IP) address.

What is claimed is:

1. A pool or spa system comprising:
a first electrical enclosure, comprising:
a first electrical power source; and
a first wireless networking device configured to receive power from the first electrical power source and communicate with one or more first pieces of pool or spa equipment; and
a second electrical enclosure, comprising:
a second electrical power source; and
a second wireless networking device configured to receive power from the second electrical power source and communicate with one or more second pieces of pool or spa equipment and in network communication with the first wireless networking device.

2. The pool or spa system of claim 1, wherein:
the first electrical power source is configured to power the one or more first pieces of pool or spa equipment; and
the second electrical power source is configured to power the one or more second pieces of pool or spa equipment.

3. The pool or spa system of claim 1, wherein the one or more first pieces of pool or spa equipment and the one or more second pieces of pool or spa equipment are separated by a distance greater than a range of the first wireless networking device.

4. The pool or spa system of claim 1, wherein the first electrical enclosure further comprises a pool automation controller configured to operate the one or more first pieces of pool or spa equipment and the one or more second pieces of pool or spa equipment.

5. The pool or spa system of claim 1, wherein the first wireless networking device and the second wireless networking device provide a wireless network, wherein the wireless network is characterized by a service set identifier (SSID) and an internet protocol (IP) address.

6. The pool or spa system of claim 5, wherein the first wireless networking device includes a first wireless access point, and the second wireless networking device includes a second wireless access point.

7. The pool or spa system of claim 6, further comprising a pool automation controller, wherein the pool automation controller comprises:
one or more non-transitory computer-readable media; and
one or more processors communicatively coupled to the one or more non-transitory computer-readable media, the one or more processors configured to execute processor-executable instructions stored in the non-transitory computer-readable media to perform operations including:
receiving first configuration information for the first wireless access point including the SSID and the IP address;
receiving second configuration information for the second wireless access point; and
outputting the first configuration information to the first wireless access point and the second configuration information to the second wireless access point to initialize the wireless network by causing the first wireless access point to communicate with the second wireless access point.

8. The pool or spa system of claim 7, wherein the non-transitory computer-readable media comprises additional processor-executable instructions, and wherein the one or more processors are configured to execute the additional processor-executable instructions to perform operations including:
receiving first information about a first piece of pool or spa equipment of the one or more first pieces of pool or spa equipment;
receiving second information about a second piece of pool or spa equipment of the one or more second pieces of pool or spa equipment;
outputting a first command to cause the first wireless access point to communicate wirelessly with the first piece of pool or spa equipment; and
outputting a second command to cause the second wireless access point to communicate wirelessly with the second piece of pool or spa equipment.

9. The pool or spa system of claim 8, wherein the operations further include outputting a third command to change a mode of operation of the first piece of pool or spa equipment or the second piece of pool or spa equipment.

10. The pool or spa system of claim 7, wherein the operations further include updating a second SSID of the second wireless access point to match the SSID of the wireless network.

11. The pool or spa system of claim 1, further comprising:
a plurality of extended electrical enclosures, each enclosure comprising:
an electrical power source; and
a wireless networking device configured to communicate with the one or more other pieces of pool or spa equipment and in network communication with the first wireless networking device.

12. The pool or spa system of claim 1, wherein the first electrical enclosure further comprises a wireless router connected to a first external network.

13. A method of configuring a wireless network for a pool or spa system, comprising:
receiving first configuration information for a first wireless access point including a SSID and an IP address, wherein the first wireless access point is included in a first electrical enclosure and is configured to communicate with one or more first pieces of pool or spa equipment;
receiving second configuration information for a second wireless access point, wherein the second wireless access point is included in a second electrical enclosure and is configured to communicate with one or more second pieces of pool or spa equipment; and
outputting the first configuration information to the first wireless access point and the second configuration information to the second wireless access point to initialize the wireless network by causing the first wireless access point to communicate with the second wireless access point.

14. The method of claim 13, wherein the one or more first pieces of pool or spa equipment and the one or more second pieces of pool or spa equipment are separated by a distance greater than a range of the first wireless networking device.

15. The method of claim 13, wherein the first electrical enclosure further comprises a pool automation controller configured to operate the one or more first pieces of pool or spa equipment and the one or more second pieces of pool or spa equipment.

16. The method of claim 15, further comprising:
receiving, from a user interface of the pool automation controller, first information about a first piece of pool or spa equipment of the one or more first pieces of pool or spa equipment;
receiving, from the user interface of the pool automation controller, second information about a second piece of pool or spa equipment of the one or more second pieces of pool or spa equipment;
outputting, by the pool automation controller, a first command to cause the first wireless access point to communicate wirelessly with the first piece of pool or spa equipment; and
outputting, by the pool automation controller, a second command to cause the second wireless access point to communicate wirelessly with the second piece of pool or spa equipment.

17. The method of claim 16, further comprising outputting a third command to change a mode of operation of the first piece of pool or spa equipment or the second piece of pool or spa equipment.

18. The method of claim 13, further comprising updating a SSID of the second wireless access point to match the SSID of the wireless network.

19. A method for deploying a wireless network for a pool or spa system, comprising:
installing a first wireless networking device in a first electrical enclosure configured to communicate with one or more first pieces of pool or spa equipment located in a first region, wherein the first wireless networking device has a first range;
installing a second wireless networking device in a second electrical enclosure configured to communicate with one or more second pieces of pool or spa equipment location in a second region, the first region and the second region separated by a distance greater than the first range; and
deploying the wireless network comprising the first wireless networking device and second wireless networking device.

20. The method of claim 19, wherein deploying the wireless network comprises:
receiving first configuration information for the first wireless networking device including an SSID and an IP address;
receiving second configuration information for the second wireless networking device; and
outputting the first configuration information to the first wireless networking device and the second configuration information to the second wireless networking device to initialize the wireless network by causing the first wireless networking device to communicate with the second wireless networking device, wherein the wireless network is characterized by a service set identifier (SSID) and internet protocol (IP) address.
